(19) United States
(12) Patent Application Publication
(10) Pub. No.: US 2026/0306942 A1
(43) Pub. Date: Oct. 8, 2026

(54) GAMEPLAY VIDEO SYSTEM AND METHOD

(71) Applicant: Sony Interactive Entertainment Inc., Tokyo (JP)

(72) Inventors: Nabajeet Barman, London (GB); Andrew James Bigos, London (GB); Saman Zadtootaghaj, London (GB); Daniel Montero Motilla, London (GB); Matthew William Sanders, London (GB)

(73) Assignee: Sony Interactive Entertainment Inc., Tokyo (JP)

(21) Appl. No.: 19/349,776

(22) Filed: Oct. 3, 2025

(30) Foreign Application Priority Data
Oct. 8, 2024 (GB) 2414768.8

(51) Int. Cl. A63F 13/355; H04N 21/2343; H04N 21/235; H04N 21/478

(52) U.S. Cl. CPC A63F 13/355; H04N 21/2343; H04N 21/2353; H04N 21/4781; A63F 2300/538

(57) ABSTRACT

A system is configured to encode video of a game being executed, the video being encoded for transmission to a client device operated by a player of the game. The system comprises a game execution unit configured to execute the game, wherein executing the game comprises rendering a plurality of image frames for display to the player, an encoding unit configured to encode the video of the game being executed, the encoded video comprising the plurality of image frames for display to the player, and a display metadata determining unit. The display metadata determining unit is configured to determine display metadata indicating at least one property relating to a rendered image frame of the encoded video for making a display decision regarding the rendered image frame, and the encoding unit is configured to encode the display metadata for transmission to the client device with the encoded video.

### CROSS-REFERENCE TO RELATED APPLICATIONS

This application claims the benefit of and priority to United Kingdom (GB) Application No. 2414768.8, filed Oct. 8, 2024, the entire disclosure of which is incorporated by reference herein in its entirety for all purposes.

### BACKGROUND

### Field

This disclosure relates to a system and method for providing gameplay video to a client device.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Video games have traditionally been played using a local games console or other processing device (such as a personal computer or mobile phone). However, for many users the ability to leverage processing capabilities of a remote device and instead stream gameplay video to a local device has become increasingly appealing.

For some users, this can be achieved by using an in-home streaming arrangement in which a powerful processing device (such as a games console or personal computer) is used to execute a game. The video output of this game can then be streamed over a local network to a less-powerful processing device, such as a tablet computer, mobile phone, or handheld gaming device. This allows a user to play content that can be executed more effectively (e.g., at a higher visual quality) by the more powerful processing device (due to system requirements, for instance), without being tied to the location or form factor of that device.

In some cases, a user may not have access to or wish to make use of a powerful local processing device. Hence in some situations a user may instead stream gameplay video from a remote source-this can be a games console or the like in another location, for example, or a cloud gaming server. In any case, the gameplay video produced by the remote processing device can be received by the user's device, such as a mobile phone or portable device, via the internet.

To ensure that a user is able to experience a good quality of gameplay in streaming arrangements it is important that the gameplay video can be reproduced with reduced latency and increased visual quality. This enables a user to respond to events within the games in a timely manner, as well as to view content with a good level of detail.

It is in the context of the above discussion that the present disclosure arises.

### SUMMARY

Aspects and features of the disclosure are defined in the appended claims.

It is to be understood that both the foregoing general description of the disclosure and the following detailed description are exemplary, but are not restrictive, of the disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 schematically illustrates a video streaming system;

FIG. 3 schematically illustrates elements of the video streaming system;

FIG. 4 illustrates a method of encoding game video; and

FIG. 5 illustrates a method of decoding game video.

### DESCRIPTION OF THE EMBODIMENTS

Referring now to the drawings, wherein like reference numerals designate identical or corresponding parts throughout the several views, embodiments of the present disclosure are described.

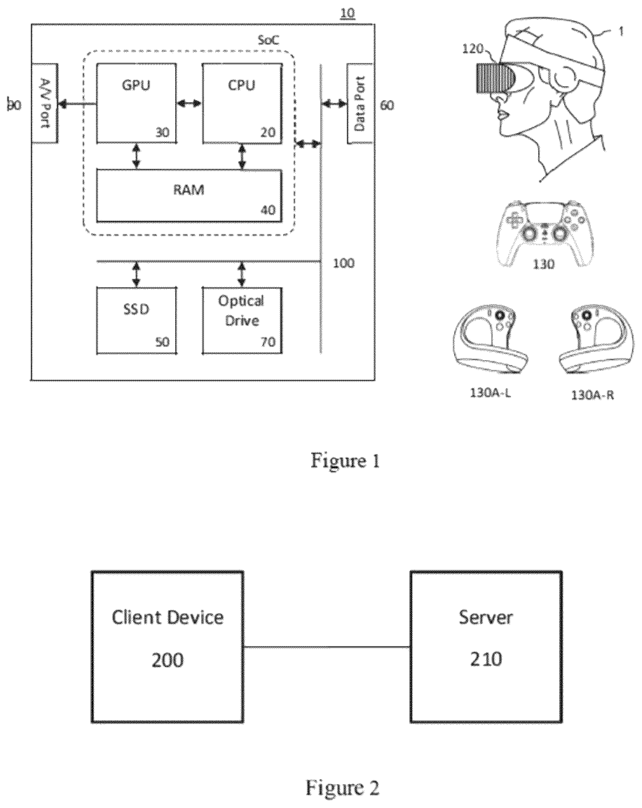

Referring to FIG. 1, an example of an entertainment system 10 is a computer or console.

The entertainment system 10 comprises a central processing unit (CPU) 20. The entertainment system also comprises a graphical processing unit (GPU) 30, and random access memory (RAM) 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a universal serial bus (USB) port, Ethernet® port, Wi-Fi® port, Bluetooth® port or similar, as appropriate. It may also optionally receive data via an optical drive 70.

Audio/visual (A/V) outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L, R) in the case of the HMD.

FIG. 2 schematically illustrates a streaming system in accordance with implementations of the present disclosure. In this Figure, a single client device 200 is shown in communication via a network (represented by the line) with a server 210. Of course, in practice a plurality of client devices may be in communication with a single server, and a client device may be in communication with multiple servers at the same time. While referred to here as a ‘server’, the unit 210 may be any suitable processing device which is configured to execute a video game and provide video of the gameplay to another device via a network or internet connection.

The client device 200 may be implemented as an entertainment device 100 as shown in FIG. 1, for example, or any other processing hardware. Examples of client devices include game consoles, mobile phones, other portable devices, computers, televisions, and laptops.

The server 210 may be implemented using any suitable processing hardware, and may include any suitable configuration of CPUs and/or GPUs required to execute a game to generate the video content to be streamed to the client device. Of course, the server 210 should also include communication means to enable communication with the client device 200 over the network connection. The network may be provided by a local area network or by the internet, for example.

Typically, a game streaming arrangement executes a video game to generate images for display based upon received inputs from the client device. These generated images are then encoded in real-time into a video stream for transmission to the client device, where the video is to be displayed to a user (who then views the video, and provides inputs to control the gameplay).

In prior examples of game streaming arrangements, the client device 200 has been provided with encoded video data for display via a particular display device to the user. However, the client device has not previously been provided with any information indicating how to display the received video. As such, in prior arrangements the client device 200 has been “blind”, and has had to rely on predictions or estimations about the received video when making a decision on how to display the streamed game video. For instance, the client device has had no information about the quality of the received video and has hence had to rely on a no-reference image quality assessment when considering the video quality to decide how to display the game video.

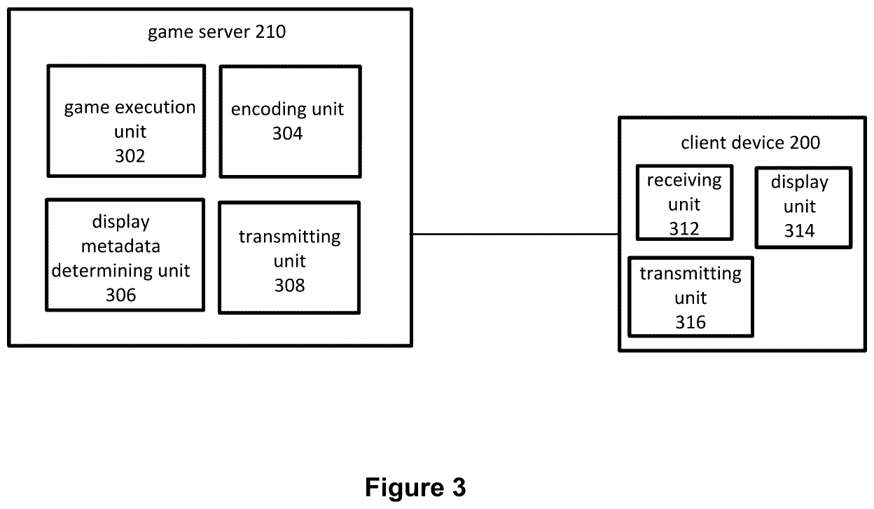

FIG. 3 schematically illustrates a system according to examples of the present technique, which is configured to encode video of a game being executed, the video being encoded for transmission to a client device operated by a player of the game.

The system comprises a game server 210 comprising a game execution unit 302, an encoding unit 304, a display metadata determining unit 306, and a transmitting unit 308. These units may be implemented using any suitable processing hardware (such as one or more CPUs and/or GPUs) located within a device for remotely executing gameplay.

The game server 210 is configured to transmit encoded gameplay video to a client device 200 comprising a receiving unit 312 to receive encoded video from the game server 210, a display unit 314 to process the received video for display to a user, and a transmitting unit 316 to transmit user inputs and any other relevant information to the game server 210.

The game execution unit 302 is configured to execute the game, wherein executing the game comprises rendering a plurality of image frames for display to the player. The game execution unit 302 is further configured to receive inputs from the player to control the gameplay, for instance over a network connection which enables communication between the game server 210 (exemplified by a cloud gaming server or remote games console) and the client device 200 associated with the player.

The encoding unit 304 is configured to encode the video of the game being executed, the encoded video comprising the plurality of image frames for display to the player.

The transmitting unit 308 is configured to transmit the encoded video to a client device 200 configured to display the video to a player. Optionally, the encoded video may be sent to one or more spectators simultaneously although in some cases it may be preferred that a time delay is introduced to prevent spectators from receiving real-time updates about the players gameplay (which can cause problems in multiplayer games, for instance).

The display metadata determining unit 306 is configured to determine display metadata, which is information other than the encoded video, which indicates at least one property relating to a rendered image frame of the encoded video for making a display decision regarding the rendered image frame. Determining and transmitting the display metadata to a client device 200 can enable the client device 200 to make a display decision regarding the encoded video.

As discussed below, there may be several examples of information which could be provided, either alone or in combination, as display metadata to provide the client device 200 with additional information which it may use to make a decision about how to display the encoded game video.

By generating and transmitting the display metadata to the client device, the client device 200 is provided access to information which can be used to make a decision about how to best display the game video to the player. For example, the display metadata can provide the client device 200 with information from which the client device 200 may decide which post-processing operations to apply to the received encoded video. This can allow game video to be displayed to a player with the most appropriate settings for a given scenario, having regard to various factors such as the quality of transmitted video and the current state of the game. This can allow the displayed video to be reproduced with the lowest latency and highest video quality within the constraints identified by the display metadata.

The display metadata may provide the client device 200 with information which it would not otherwise have access to, e.g., if such information is not derivable based on the transmitted video data alone, and can hence enable display decisions to be made which would not have been possible in prior techniques. In some examples, although the client device 200 may have been able to derive some of the transmitted information from the encoded video (e.g., to a limited degree, the quality information), providing the information from the game server 210 using the display metadata may both provide more complete information and reduce a processing burden imposed on the client device by reducing the amount of analysis performed at the client device 200, and can hence support video game streaming for lower performance client devices 200.

In some examples, the display metadata may comprise game-related information indicating at least one property of the executed game relating to the rendered image frame. Such game-related information may be obtained from the game execution unit 302, for example game-related information may be directly obtained as an output from a game engine executed by the game execution unit 302. Hence the display metadata may be obtained from the source of the video content, and not merely obtained from the video content itself. The game-related information could however in some examples be determined based on the rendered image frames of the game, for example using image recognition of the rendered image frames to derive game-related information.

There may be several aspects of game-related data which could be considered by a client device 200 when considering how to display streamed video game data.

For instance, the game-related information may comprise an indication of a current gameplay level of a game. For example, the game data may identify a level of progress of the player through a current game being played. The game data may also indicate motion information relating to a current stage of gameplay, and a complexity mode of the game. These items of information may be indicative of various properties of the encoded video data which could be relevant when deciding how to display that video.

For example, graphical complexity of a game may vary throughout the stages of a game. For example, early stages of a game may be fairly introductory and simple and hence visually straightforward, whilst later stages may comprise a greater number of visual elements (e.g., more obstacles, opponents, etc.), and hence the game level may provide an indication of how complex a particular frame of video is expected to be. As discussed in greater detail below, the complexity of a frame may impact how that frame should be processed for display, and hence the game level may be one factor influencing a decision of a client device 200 when deciding how to display video data. The game level may also indicate a latency sensitivity of the encoded video. For example, at certain stages of a game (e.g., boss fights or quick time events) the timing of inputs provided by the player in response to the delayed video may be particularly important, and hence when different methods for displaying the encoded video (e.g., different degrees of post-processing) affect the latency the game, the game level may provide information for deciding how the client device 200 should display the encoded video.

The game level information may be provided in various ways. For example, a single numerical value could be provided indicating, at some granularity, an amount of progress through a game (such as a level number, a stage number, which checkpoint the player is at, and so on). Alternatively, two or more values could be provided indicating different aspects of the player's progress through the game (e.g., one value indicating progress through the story and a further value indicating a character's experience level, where each value may be relevant to an overall complexity of the game). In some examples, the game level information may indicate a progress value specific to a particular game (e.g., when the client device has knowledge of complexity associated with specific parts of that game). In other examples, the game level information may be processed to provide a generalised complexity value to reduce the amount of game specific knowledge needed by the client device.

Motion information relating to a current stage of gameplay and a complexity mode of the game may have similar considerations for deciding how to display video data. Greater levels of motion in the displayed game video and higher game complexity may require video to be displayed at a higher quality to allow details to be distinguished, for example, while high motion and high complexity may be indicative of latency-sensitive stages of gameplay in which post-processing should be reduced to minimise latency.

Hence, in some examples, the display metadata may be indicative of a latency sensitivity of a current stage of the game. For video of a game which is more sensitive to latency (e.g., higher intensity action sequences), display decisions may be made to minimise how much delay is incurred between receiving and displaying received video data (e.g., reducing an amount of post-processing), while for games which are less sensitive to latency (e.g., slower paced sequences of a game, such as cinematic sequences) the decision may be made to perform greater levels of post-processing to maximise image quality at the cost of incurring a larger delay between receiving video data and displaying that video to a user. Information regarding the latency sensitivity of a current stage of the game may not be information which could be derived from the encoded video data alone, and hence providing this information as display metadata from the game server 210 may enable decisions to be made more effectively at the client device 200.

Other examples of game-related information may comprise an indication of a user's playstyle. For example this may involve determining whether the playstyle is slow and steady, or frantic and trigger-happy, where the playstyle may be correlated to the visual complexity and/or latency sensitivity of the streamed gameplay. The game-related information may comprise an indication of a loadout of a player character (if they have ‘boots of speed’ the motion complexity is likely to be higher due to increased movement speed of the player character, and therefore camera viewpoint, for example). The game-related information may comprise information about visual objects currently present in the game, such as specific enemy types (how much/fast do they move, and how spatially complex are the textures).

The game-related information may in some examples be directly obtained from the game execution unit 302. In other examples, the display metadata determining unit may be configured to process data obtained from the game execution unit 302 and/or from the encoded video to determine the game-related information.

In some examples, the display metadata may comprise an indication of a complexity of the encoded video. Complexity may be used as an indication of how much compression video has undergone. When using the same settings, a more complex video sequence may be less compressible, and hence when received at a given bitrate a more complex video may need to be handled differently than a less complex video due to the different levels of redundancy able to be exploited between frames, for instance.

Hence, providing complexity information to the client device 200 with the encoded video can enable more informed decisions to be made for displaying the video to the player.

Complexity for video encoding may consist of two different aspects—spatial complexity and temporal complexity. Spatial complexity is a measure of the amount of detail present within a frame, such that content with large areas of relatively uniform content (such as the pitch in a football match) is considered to have a low degree of complexity. Meanwhile, temporal complexity is a measure of the amount of movement between frames; as such, video comprising objects that have a high velocity are typically considered to have a higher temporal complexity. The degree of complexity can be quantified in any suitable manner, with one approach being the use of energy functions for this purpose.

In some examples, the display metadata determining unit 306 may determine display metadata indicating the complexity of the encoded video, based on the encoded video itself. For example, the complexity of a particular frame can be computed using the following formula, as defined in ITU-T Rec.910: complexity=st d_{space}[Sobel(Fₙ)]. The Sobel filter is applied to all the points of frame Fₙ and the standard deviation over all the pixels is computed to provide a measure of the complexity of the frame. It will be appreciated that other methods could also be used to provide a measure of complexity based on the encoded video data.

However, determining complexity based on the encoded video could add latency at the server side, and hence in some examples more efficient methods could be employed to provide complexity information. For instance, the complexity of game video may be predicted based on one or more items of game data.

The display metadata determining unit 306 may for example be configured to obtain information about the game being executed—this may be the game itself, or one or more higher-level parameters associated with the game (rather than details about the rendering itself). For instance, the obtained information about the game being executed may include one or more of a title of the game, a current level being played, a genre associated with the game, a difficulty setting associated with the game, and one or more graphics settings associated with the game. The display metadata determining unit may then estimate a spatial and/or temporal complexity of the encoded video based on the information obtained from the game execution unit 302.

The display metadata determining unit 306 may be configured to perform a complexity analysis for the entire image frame, or may be configured to consider the complexity on a more refined basis as appropriate. For instance in the case that a sound source localisation or other processing indicating a location of a sound source is performed, the complexity of an image region associated with that sound source may be derived. This complexity estimation may be based upon information indicating the spatial complexity of an object identified as the sound source; this information may be obtained from metadata associated with the object and/or audio file, and/or a central lookup table or the like.

In some implementations, the display metadata determining unit 306 may be configured to obtain complexity information for one or more frames preceding the frame currently being rendered and to use this complexity information when estimating the spatial and/or temporal complexity of the image frame being rendered. This obtained complexity information may be earlier estimations, or may include calculated measures of complexity which are determined after the rendering of the respective frame or frames. In some cases, a mixed approach may be utilised in which more recent frames are associated with an estimation so as to enable time for the calculations of the complexity to be performed.

In some examples, complexity could be predicted based on the use of audio, haptic, or text data obtained from the game as the game data; such data can include background music, sound effects, captions, text descriptions of a scene (for example, generated by a game for accessibility purposes), haptic feedback (typically described using a waveform, and so analogous to audio), or subtitles.

Complexity could be predicted based on game data utilising a predefined algorithm, which may be specific to particular games or genres (for example), which weights various factors defined by the game data to estimate complexity. Alternatively, or in addition, a trained machine learning model may be used to derive an estimated complexity on the basis of the game data information.

This may include an overall complexity estimate, and/or individual estimates of the spatial complexity and/or the temporal complexity. These estimates may be derived on a frame-by-frame basis for each frame or a subset of frames (such as every second or third frame), or may be generated for a group of frames (or indeed partial frames) as appropriate for a given implementation. Hence, data output by the game itself can be used for a complexity estimation rather than relying on the generated video itself (that is, a rendering result). This means that the advantages of providing display metadata including a complexity estimation may be realised without adding a significant latency burden to the video streaming process.

An example of the implementation of such a method is in an open world game which is being streamed to a user. Significant portions of such games often have a low temporal complexity associated with the imagery—as a user explores a world, they often do so at a relatively low pace and with few interactions with fast-moving objects. Such an exploration typically coincides with background audio having a relatively low intensity, and a reduced number of sound effects (or at least sound effects which are low intensity—such as walking-pace footsteps and the like).

This is in contrast to an encounter with enemies within that same game—in that case, the number of moving objects (such as the enemies) in the scene is increased and the speed of such movement may be relatively high due to the user changing their viewpoint more frequently as a part of the engagement. The level of temporal complexity of associated images is therefore increased relative to the exploration part of the game; it is also considered that the spatial complexity may be similarly increased due to the number of different models that may be present (and therefore offering more variety than open grassland or sky, for example).

As such, it is clear that there is a correlation within a game between audio and the encoding complexity of corresponding image frames. In some implementations this correlation may be derived across for a single game title, while in others a more generalised approach may be taken in which correlations are derived on a multi-game basis such as across a particular series of games, genre of games, games using shared or similar audio assets, or any other selection of games.

Similar considerations apply for the other sources of data discussed above. For instance, haptic feedback is expected to increase in periods of high in-game intensity—and in such periods, the image complexity is expected to increase accordingly. Similarly, subtitles (either generated by the game, or derived from the audio directly) can be descriptive of events within the content—or even their presence can be a sign of particular events (for instance, in some games it is common for the imagery to become relatively static during conversations to enable the user to focus on the conversation). Captions and scene descriptions can also be considered similarly, with scene descriptions in particular, being able to offer a specific insight into the content of the images.

While described above as being used in isolation, in some implementations the complexity may be estimated on the basis of multiple sources of information. For example, both the audio and haptics may be considered, or any other combination of two or more data sources. An estimation of the complexity may be based upon each of these data sources in combination, or separate estimations of the complexity may be generated for each data source and a representative value (such as a weighted or unweighted average, a modal value, or a median value) may be derived from these separate estimations with the representative value being taken as the complexity estimate.

Hence, an estimation of complexity may be made based on game data obtained from the game execution unit 302, and the complexity may be transmitted to the client device 200 to enable the client device to decide how to display the streamed gameplay video.

In some examples, the display metadata may comprise an indication of a video quality of the encoded video.

The video quality indication may be provided in various ways, and may generally indicate a measure of video quality of the encoded video transmitted to the client device. The client device can base a display decision on the received quality information. For example, the client device 200 may decide to perform a greater degree of post-processing on lower quality video to provide suitable quality gameplay video to the player, whilst making a decision to perform less post-processing on video which is received with a higher quality, where avoiding unnecessary post-processing may for example allow that video to be displayed with lower latency.

Compared to relying on a no-reference quality assessment at the client device 200, providing quality information as display metadata may increase the accuracy of the quality information available to the client device 200 and/or reduce an amount of quality assessment processing performed by the client device, which can both reduce latency and reduce a processing burden on the client device.

In some examples, the encoding unit 304 may be configured to carry out rate-distortion optimisation when encoding video, to optimise the amount of data required to encode the video based on encoding video quality information. That is, the encoding unit 304 may already have information indicating the quality of the encoded video, which it may use during rate-distortion optimisation to select a quality at which to encode the video data to optimise usage of transmission bandwidth when transmitting the video to the client device. The same video quality information may be encoded for transmission to the client device 200 to indicate the quality of the transmitted video to the client device. This therefore represents an efficient method for obtaining display metadata for transmission to the client device, requiring little additional analysis at the game server.

Various examples of video quality information may be provided as display metadata to the client device 200. For example, the indication of the video quality may comprise at least one of a mean-square error (MSE), a peak signal-to-noise ratio (PSNR), and a structural similarity index metric (SSIM). The video quality information may apply to a particular frame, portion of a frame, or may be averaged over a set of two or more frames.

In some examples, the display metadata may comprise an indication of one or more pre-processing steps performed on the encoded video prior to the encoded video being transmitted to the client device. For example, the video encoding unit may be configured to perform one or more pre-processing steps on the plurality of image frames rendered by the game execution unit, for example to reduce an amount of video data transmitted or to modify a display characteristic of the video. The selection of which pre-processing steps were performed on the encoded video can be relevant to decisions made by the client device regarding display of the rendered image frame. For example, if a particular processing step has been performed on the encoded video prior to transmission then the client device may not need to carry out the same processing on the received video, and hence latency can be reduced by avoiding performing unnecessary post-processing of the encoded video. If a particular processing step has been performed on the encoded video prior to transmission then this may also affect whether the client device should carry out particular further processing steps in dependence on the pre-processing step. For example, if the display metadata indicates that an aspect of display quality has been reduced in a pre-processing step then a display decision may be made to perform post-processing to increase that aspect of display quality of the received video prior to display to the player.

Hence, various items of display metadata may be provided to the client device to enable the client device to make more intelligent decisions about which post-processing algorithms to apply, which rendition to request, etc.

For example, for a low-quality video stream at a lower resolution than the display size and less delay-sensitive gameplay video, the client can apply both denoising and super-resolution algorithms to improve the end user quality. This can be particularly beneficial for cinematic scenes, for example, in which the improved video quality can enhance the user experience without the additional latency significantly impacting gameplay.

However, if the video is of low quality at a lower resolution but is of a latency-sensitive nature, the client may decide to apply either the denoising or super-resolution algorithm or none of them (or a simpler less computationally expensive version of them). Hence, higher action sequences of the same game may be handled differently, such that gameplay can be more responsive when required so that post-processing does not impact the user experience by adding frustrating timing delays.

Other post-processing algorithms such as video frame interpolation, inpainting, etc. can also be similarly used based on the game metadata and quality information.

The display metadata can hence enable display decisions to be made by a client device dynamically based on various aspects of the gameplay video being transmitted to the client device at a particular time. Whilst static display settings can be frustrating to a user (because they may either sacrifice video quality unnecessarily or add latency at inopportune moments in the game), transmitting display metadata can allow display settings to be continuously updated by the client device to track the gameplay, and hence avoid the requirement to compromise between quality or latency for a game overall.

The display metadata may be provided at different levels of precision. In some examples, the display metadata may be provided for particular frames of the encoded video, e.g., display metadata may be provided for each frame of the encoded video indicating information about that frame and allowing the client device to determine how to display that frame. In other examples, at least some of the display metadata may be provided at a different level of precision. For example, the display metadata may be provided for a particular packet. If a particular frame is represented by data provided in multiple packets, then providing display metadata for each packet may provide a greater volume of display metadata than sending display metadata once per frame, and hence may allow more accurate display decisions to be made. On the other hand, providing the display metadata at a coarser granularity (e.g., once per frame) may reduce accuracy but may also reduce the overhead associated with transmitting the display metadata and hence enable the display metadata to be transmitted more efficiently.

In some examples, at least a portion of the display metadata may be provided for a set of two or more frames. Certain elements of display metadata (e.g., a current gameplay level) may change relatively infrequently. For these items of display metadata, there may be little benefit in transmitting the display metadata for each frame (compared to information which may change more rapidly and hence be transmitted more frequently, such as complexity which may be transmitted each frame). Hence, certain items of display metadata may be sent less frequently to reduce the volume of redundant information transmitted to the client device. In some examples, different aspects of the display metadata may be transmitted at different frequencies such that display metadata which changes more rapidly may be sent more frequently whilst display metadata which changes more slowly may be sent less frequently. This can avoid making unnecessary compromises between the accuracy of the transmitted information and volume of transmitted information, as decisions can be made differently for different parts of the display metadata.

The encoding unit 304 may encode the display metadata in various ways. In one example, the encoding unit 304 may provide the display metadata as a separate bitstream alongside a bitstream comprising the encoded video. In other examples, the display metadata may be embedded in the encoded video bitstream. Embedding the display metadata may provide a more efficient implementation, reducing overhead.

If the display metadata is embedded in the video bitstream, this could be implemented in various ways. For example, one or more fields may be added to the packet header of the encoded video bitstream to provide the display metadata. For example, the additional field could provide a quality metric or compression metric as a single integer value (e.g., int8) in the header of each packet.

The receiving unit 312 of the client device 200 may comprise a modified decoder configured to decode and parse the header packet (or the encoded bitstream more generally) to retrieve the additional display metadata and provide the display metadata to the display unit 314 to make a display decision. For example, the display metadata may be fed into an algorithm to make intelligent client decisions (such as available computational power, complexity of various post-processing algorithms, quality and complexity of the received game video stream and the type of game being played).

The client device 200 may also comprise a transmitting unit 316 configured to transmit information regarding the display decision to the game server. Hence, the server may provide display metadata to the client device, the client device may make a display decision on the basis of the display metadata, and the client device may then return to the server details of the currently selected client-side display decision, which the server can use to optimise further the content it transports.

Hence, the arrangement of FIG. 3 includes an example of a processor (for example, a GPU and/or CPU located in a games console or any other computing device) that is operable to encode video of a game being executed, the video being encoded for transmission to a client device operated by a player of the game, and in particular is operable to:
execute the game, wherein executing the game comprises rendering a plurality of image frames for display to the player;
encode the video of the game being executed, the encoded video comprising the plurality of image frames for display to the player;
determine display metadata indicating at least one property of the encoded video to enable the client device to make a display decision regarding the encoded video; and
encode the display metadata for transmission to the client device with the encoded video.

In particular, this may be implemented by a server (such as the server 210 of FIG. 2), with the client device being any suitable games console or other processing device configured to receive a video stream and display that stream.

The arrangement of FIG. 3 also includes an example of a processor that is operable to display a game being executed by a game server, and in particular is operable to:
receive encoded video comprising a plurality of image frames of the game;
process the encoded video to provide video for display to a player of the game;
transmit inputs from the player of the game to the game server; and
make a display decision regarding the encoded video based on display metadata received from the game server with the encoded video.

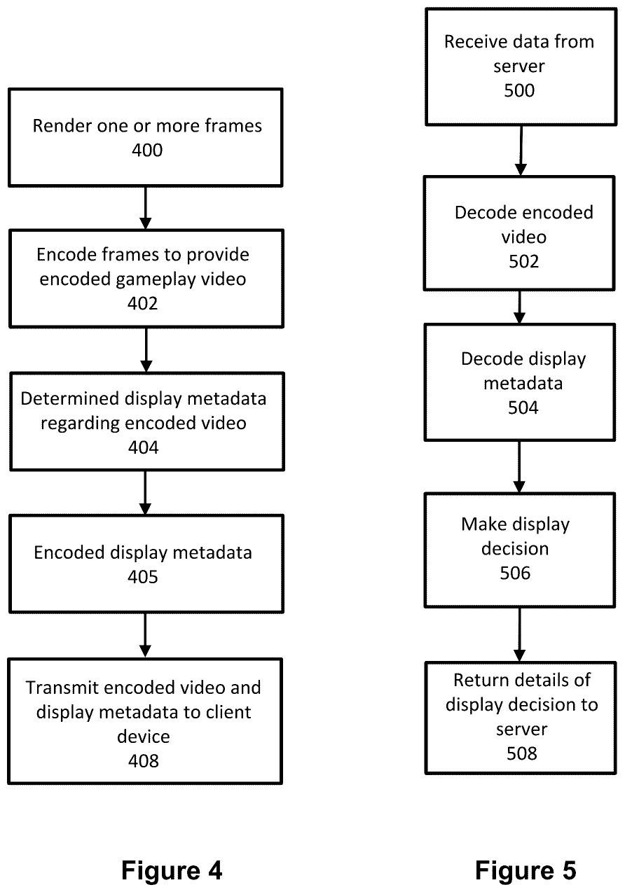

FIG. 4 schematically illustrates a method of encoding video of a game being executed, for transmission to a client device operated by a player of the game. The method may be performed by a system according to FIG. 3, for example.

At step 400, the game execution unit 302 executes the game, wherein executing the game comprises rendering a plurality of image frames for display to the player. The rendered frames are based on the output of a game engine executed by the game execution unit 302. The game engine takes inputs from a client device 200 operated by a player of the game, which are received remotely over a network (such as the internet or a local area network).

At step 402, the encoding unit 304 encodes the frames output by the game execution unit 302 to provide an encoded video of the game. Various encoding schemes can be used, the present techniques are not limited to a particular encoding scheme. In some examples, an encoding scheme may be used which encodes video data in packets for transmission to the client device. Packets are discrete objects for transmission over the network to the client device and may comprise a header, which is a portion of the packet indicating information about the data contained in the packet. The encoding unit 304 may determine various properties about the encoded video, such as quality metrics, which may be used when encoding the video (e.g., to perform rate-distortion optimisation).

At step 404, the display metadata determining unit 306 determines at least one property of the encoded video which may allow a client device to make a decision about how to display the encoded video. As described in various examples above, the display metadata may for example include information about the state of the game represented by the encoded video, where such information may be obtained from the game execution unit (e.g., as a direct output from the game engine). The display metadata may also indicate information about the complexity of the transmitted video, which could be obtained by analysing the rendered from the game execution engine, or could be obtained based on game data obtained directly from the game engine itself. The display metadata may also indicate information about the quality of the encoded video, for example indicating a resolution or noise level of the encoded video.

At step 406, the encoding unit 304 encodes the display metadata determined at step 404 in a bitstream for providing to the client device. The display metadata may be encoded in a separate bitstream or may be embedded in the same bitstream used for transmitting the encoded video. For example, the display metadata may be added to a packet header of packets used to transmit the encoded video data.

At step 408, the transmitting unit 308 transmits the encoded video and the display metadata corresponding to that encoded video via a network to the client device 200 to enable the video to be displayed to a user.

FIG. 5 schematically illustrates a method of receiving video of a game being executed, for display to a player of the game. The method may be performed by a system according to FIG. 3, for example.

At step 500, the receiving unit 312 receives one or more bitstreams providing data transmitted by the transmitting unit 308 of the game server 210.

At step 502, the receiving unit 312 decodes the received data to obtain gameplay video and provides the decoded video to the display unit 314.

At step 504, the receiving unit 312 decodes the received data to obtain display metadata relating to the obtained gameplay video and provides the display metadata to the display unit 314. It will be appreciated that steps 502 and 504 may be performed in parallel.

At step 506, the display unit 314 makes one or more display decisions to determine how to display the gameplay video (e.g., on a screen) to the player, on the basis of the display metadata.

For example, the display unit 314 may determine which post-processing operations to apply to the gameplay video on the basis of the display metadata.

At step 508, the transmitting unit 316 of the client device 200 may optionally transmit details of the display decision back to the server. The transmitting unit 316 also transmits user input information to the server to be used as an input to the game engine.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A system comprising:
one or more memory devices configured to store instructions; and
one or more processors, that upon execution of the instructions, are configured to:
execute a game, wherein executing the game comprises rendering a plurality of image frames;
encode the video of the game comprising the plurality of image frames; and
determine display metadata indicating at least one property relating to a rendered image frame of the encoded video for making a display decision regarding the rendered image frame;
encode the display metadata with the encoded video; and
transmit the encoded video and the display metadata to a client device that is configured to display the plurality of image frames.

2. The system according to claim 1, wherein the display metadata comprises game-related information indicating at least one property of the executed game relating to the rendered image frame.

3. The system according to claim 2, wherein the game-related information comprises at least one of a current gameplay level, motion information relating to a current stage of gameplay, or a complexity mode of the game.

4. The system according to claim 1, wherein the one or more processors are further configured to determine at least a subset of the display metadata based on game data obtained upon executing the game.

5. The system according to claim 2, wherein the display metadata comprises an indication of a latency sensitivity of a current stage of the game.

6. The system according to claim 1, wherein the display metadata comprises an indication of a spatial complexity of the encoded video, a temporal complexity of the encoded video, or a combination thereof.

7. The system according to claim 5, wherein the one or more processors are further configured to determine the complexity based on game data obtained upon executing the game.

8. The system according to claim 1, wherein the display metadata comprises an indication of a video quality of the encoded video.

9. The system according to claim 8, wherein the one or more processors are further configured to perform rate-distortion optimisation to optimise an amount of data required to encode the video based on encoding video quality information, and
wherein the one or more processors are further configured to determine the video quality based on the encoding video quality information used by the encoding unit for rate-distortion optimisation.

10. The system according to claim 8, wherein the indication of the video quality comprises at least one of a mean-square error, a peak signal-to-noise ratio, or a structural similarity index metric.

11. The system according to claim 1, wherein the one or more processors are further configured to determine display metadata for at least one of an image frame being rendered, a set of two or more image frames being rendered, a portion of an image frame being rendered, or each packet of video data representing the encoded video.

12. The system according to claim 1, wherein the display metadata comprises an indication of one or more pre-processing steps performed on the encoded video prior to the encoded video being transmitted to the client device.

13. The system according to claim 1, wherein the one or more processors are further configured to embed the display metadata in the encoded video.

14. The system according to claim 13, wherein the one or more processors are further configured to embed the display metadata in one or more packet headers of a plurality of packets representing the encoded video.

15. A method comprising:
executing a game, comprising rendering a plurality of image frames;
encoding video of the game comprising the plurality of image frames;
determining display metadata indicating at least one property relating to a rendered image frame of the encoded video for making a display decision regarding the rendered image frame;
encoding the display metadata with the encoded video; and
transmitting the encoded video and the display metadata to a client device that is configured to display the plurality of image frames.

16. A method for receiving video of a game from a game server, comprising:
receiving encoded video comprising a plurality of image frames of the game;
processing the encoded video to provide video for display to a player of the game;
receiving display metadata indicating at least one property relating to a rendered image frame of the encoded video; and
making a display decision regarding the encoded video based on the display metadata.
